(19) United States
(12) Patent Application Publication
(10) Pub. No.: US 2026/0003689 A1
(43) Pub. Date: Jan. 1, 2026

(54) STRUCTURED PROMPTS ACCESSIBLE THROUGH AN APPLICATION PROGRAMMING INTERFACE (API)

(71) Applicant: Apple Inc., Cupertino, CA (US)

(72) Inventors: Yingjie ZHENG, Palo Alto, CA (US); Alexander D. PALMER, San Jose, CA (US); Anthony J. CHIVETTA, San Francisco, CA (US); Arjun BHUSHAN, San Francisco, CA (US); Bowen HUANG, Mountain View, CA (US); Dacong YAN, Mountain View, CA (US); Erik D. HORNBERGER, Pittsburgh, PA (US); Guillaume Jean TARTAVEL, Tokyo (JP); Guillaume SEGUIN, San Jose, CA (US); Jeffrey A. POUND, Waterloo (CA); Jeffrey P. BIGHAM, Pittsburgh, PA (US); Joao Pedro LACERDA, Santa Cruz, CA (US); Joseph E. MEYER, Fremont, CA (US); Kit-Man WAN, Sunnyvale, CA (US); Marco ZULIANI, San Jose, CA (US); Matthew TAN TEIK HOE, London (GB); Vinay A. RAMASWAMY, Los Gatos, CA (US); Yifei HE, Cupertino, CA (US); John Dennison, Longmont, CO (US)

(21) Appl. No.: 19/245,202

(22) Filed: Jun. 20, 2025

Related U.S. Application Data
(60) Provisional application No. 63/665,224, filed on Jun. 27, 2024.

(51) Int. Cl. G06F 9/50

(52) U.S. Cl. CPC G06F 9/5027

(57) ABSTRACT

Systems and methods provide for structured prompts that are accessible through application programming interface (API.) An API request that includes one or more data elements and is indicative of a pre-defined prompt template for executing a task is received from an application process. In response, a pre-defined prompt template indicated by the API request is obtained. A prompt is generated for a machine learning model by applying the one or more data elements to the pre-defined prompt template. The prompt is provided to the machine learning model and the machine learning model processes the prompt to generate an output. The output is then transmitted back to the application process as an API response.

### CROSS REFERENCE TO RELATED APPLICATIONS

This application claims the benefit of U.S. Provisional Application No. 63/665,224,entitled “Structured Prompts Accessible Through An Application Programming Interface (API),” filed Jun. 27, 2024, the entirety of which is incorporated herein by reference.

### TECHNICAL FIELD

This disclosure relates to generative models, and more specifically to techniques for mitigating risk associated with prompts provided to generative models.

### BACKGROUND

Large language models (LLMs) are a type of artificial intelligence system designed to understand, generate, and manipulate human language. These models are built using deep learning techniques, particularly leveraging neural networks with a large number of parameters, which can process text data and learn intricate patterns in the language.

### BRIEF DESCRIPTION OF THE DRAWINGS

Certain features of the subject technology are set forth in the appended claims. However, for the purpose of explanation, several aspects of the subject technology are set forth in the following figures.

FIG. 1 illustrates an example network environment according to aspects of the subject technology.

FIG. 2 illustrates an example computing architecture for a system according to aspects of the subject technology.

FIG. 3 illustrates an example computing architecture for a system according to aspects of the subject technology.

FIG. 4 illustrates a flowchart of an example process of generating prompts according to aspects of the subject technology.

FIG. 5 illustrates a flowchart of an example process of generating prompts according to aspects of the subject technology.

FIG. 6 illustrates an example execution of application programming interface (API) instructions according to aspects of the subject technology.

FIG. 7 illustrates an example execution of application programming interface (API) instructions according to aspects of the subject technology.

FIG. 8 illustrates an example computing architecture of a device according to aspects of the subject technology.

FIG. 9 illustrates an example computing architecture of a system according to aspects of the subject technology.

FIG. 10 illustrates an example execution sequence of API instructions according to aspects of the subject technology.

FIG. 11 illustrates an example execution sequence of API instructions according to aspects of the subject technology.

FIG. 12 illustrates an example electronic system with which aspects of the subject technology may be implemented in accordance with one or more implementations.

The details above in the Brief Description of the Drawings are intended to describe only some aspects relating to certain embodiments of the innovations herein and should not be deemed in any way limiting with respect to requiring or omitting any aspect for embodiments to be claimed or otherwise limiting the disclosure or embodiments keeping with its scope or spirit.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In some implementations, structures and components are shown in block diagram form to avoid obscuring the concepts of the subject technology.

Deep learning models such as LLMs are advanced artificial intelligence (AI) systems designed to understand and generate human language. Built using neural networks with hundreds of millions to billions of parameters these models are trained on vast amounts of data enabling them to learn complex patterns and nuances in language. LLMs perform a variety of tasks including mathematical computation, data evaluation, text generation, language translation, text summarization and answering questions, etc.

Inputting incorrect or malfunctioned data into LLMs disrupts its functionality and raises security concerns. Malicious actors can exploit vulnerabilities by injecting improperly formatted inputs or harmful data potentially causing the LLMs to produce unintended or harmful outputs. Additionally, incorrect data can be used to, for example, deceive the LLM into generating inappropriate or offensive content, and/or to possibly divulge privacy-sensitive data such as training data. This can happen because the LLM interprets the malicious input as a part of the instructions rather than the content to process. These security breaches can lead to data leaks, unauthorized access to sensitive information, and the loss of user trust. Other security concerns can include a potential for denial-of-service (DOS) attacks. By flooding the LLM with complex inputs, malicious actors could overwhelm the processing capabilities of the LLM causing service disruptions and making applications unavailable to legitimate users.

In one or more implementations, a template language may be utilized, in which the runtime environment fills in portions of the template with context-specific information. This configuration can permit the rendering of a complete prompt template at runtime. Embodiments of the subject technology may provide for rendering prompts on a server side, which may contain embedded values to support runtime operations. The subject technology may prevent unauthorized prompt manipulation from a client side by constraining prompt rendering to predefined assets identified by associated IDs (e.g., ID1, ID2). The server side may verify whether the assets identified in the prompt are present and match any existing stored assets. If a mismatch occurs, the rendering process may be bypassed to mitigate the risk of server-side manipulation.

The subject technology uses pre-defined prompt templates, which are pre-defined structures or formats used to guide the input that is provided to the LLMs. By using pre-defined prompt templates, the subject system ensures a consistent structure of input prompts that can be tailored for particular tasks. This ensures that the LLM understands the context of the inputs, generating accurate and reliable outputs. By using pre-defined prompt templates, the subject system also standardizes the prompt generation process, allowing the same process to generate prompts for different LLMs hosted on different platforms.

By enforcing specific formats for prompts, the subject system minimizes the risk of the LLM interpreting harmful or unintended instructions, mitigating the risk of generating inappropriate and offensive content as output. In the subject system, the pre-defined prompt-templates are known to a model manager (or a trusted application such as an operating system) that serves as the gateway to provide inputs to the LLMs. This prevents untrusted applications from generating malicious prompts for the LLMs, minimizing the risk of malicious inputs being processed by the LLMs.

In one or more other implementations, the subject system may use topological prompting to enhance runtime operations of server-side rendering. For example, there may be redundant, colliding, and/or unneeded attention paths when rendering prompts on the server side. To mitigate this, the prompt template may define specific prompt segments where attention computations between token pairs can be omitted, leading to reductions in computational load and improvements in processing efficiency. The specific token pair configurations can be explicitly marked in the prompt template to prevent attention computations for specific pairs or specific structural regions of the prompt.

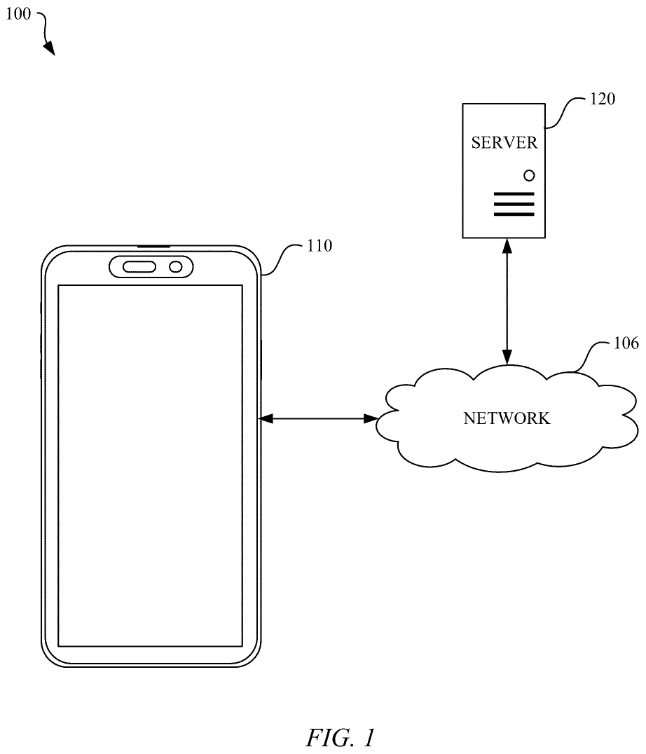

FIG. 1 illustrates an example network environment 100 in accordance with one or more implementations of the subject technology. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes a user device 110 (also referred herein to as an electronic device), and a server 120. The network 106 may communicatively (directly or indirectly) couple the user device 110 and/or the server 120. In one or more implementations, the network 106 may be an interconnected network of devices that may include, or may be communicatively coupled to, the Internet. For explanatory purposes, the network environment 100 is illustrated in FIG. 1 as including the user device 110, and the server 120; however, the network environment 100 may include any number of electronic devices and any number of servers.

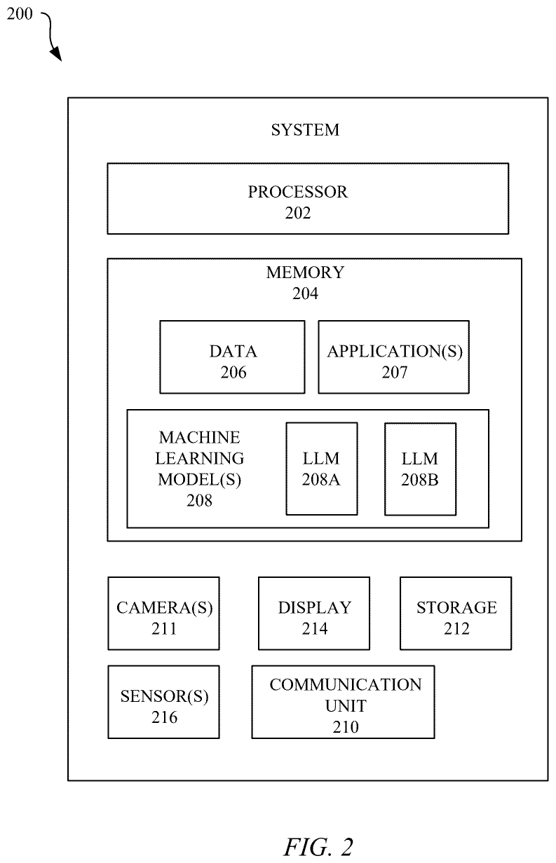

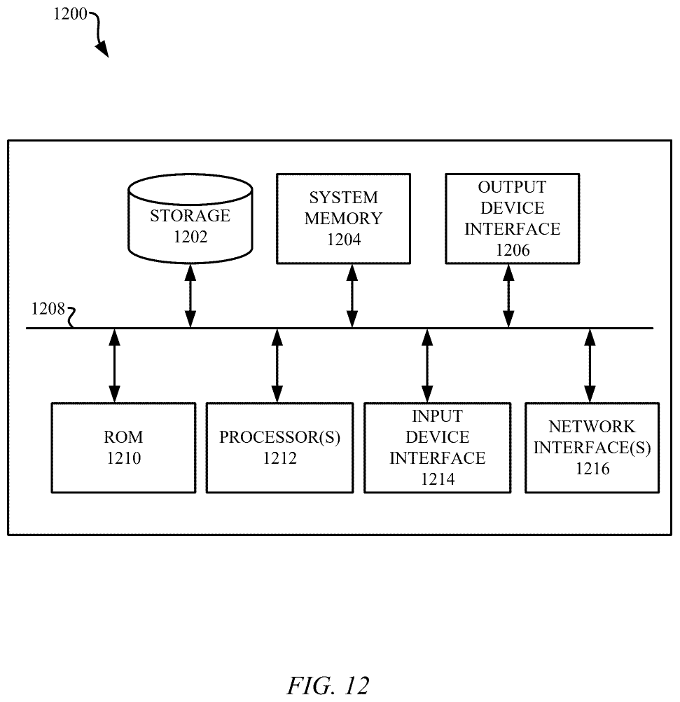

The user device 110 is depicted as a smartphone. However, it is appreciated that the user device 110 may be implemented as another type of device, such as a wearable device (e.g., a smart watch or other wearable device). The user device 110 may be a device of a user (e.g., the user device 110 may be associated with and/or logged into a user account for the user at a server). Although a single user device 110 is shown in FIG. 1, it is appreciated that the network environment 100 may include more than one user device, including more than one user device of a user and/or one or more other devices of one or more other users. The user device 110 may be, and/or may include all or part of, the systems discussed below with respect to FIG. 2 and/or FIG. 12.

The server 120 may form all or part of a network of computers or a group of servers, such as in a cloud computing or data center implementation. For example, the server 120 stores data and software, and includes specific hardware (e.g., processors, graphics processors and other specialized or custom processors, such as neural processors) for rendering and generating content such as graphics, images, video, audio, and multi-media files. In an implementation, the server 120 may function as a cloud storage server that stores any of the aforementioned content generated by the above-discussed devices and/or the server 120. The server 120 may be, and/or may include all or part of, the systems discussed below with respect to FIG. 2 and/or with respect to FIG. 12.

In one or more implementations, the user device 110 may provide a system for training a machine learning model using training data, where the trained machine learning model is subsequently deployed to the user device 110. Further, the user device 110 may provide one or more machine learning frameworks (also referred to as machine learning processes) for training machine learning models and/or developing applications using such machine learning models. In an example, such machine learning frameworks can provide various machine learning algorithms and models for different problem domains in machine learning. In an example, the user device 110 may include a deployed machine learning model that provides an output of data corresponding to a prediction or some other type of machine learning output. In one or more implementations, training and inference operations that involve individually identifiable information of a user of the user device 110 may be performed entirely on the user device 110, to prevent exposure of individually identifiable data to devices and/or systems that are not authorized by the user.

The server 120 may provide a system for training a machine learning model using training data, where the trained machine learning model is subsequently deployed to the server 120 and/or to the user device 110. In an implementation, the server 120 may train a given machine learning model for deployment to a client electronic device (e.g., the user device 110). In one or more implementations, the server 120 may train portions of the machine learning model using (e.g., anonymized) training data from a population of users, and the user device 110 may train portions of the machine learning model using individual training data from the user of the user device 110. The machine learning model deployed on the server 120 and/or the user device 110 can then perform one or more machine learning algorithms. In an implementation, the server 120 provides a cloud service that utilizes the trained machine learning model and/or continually learns over time.

FIG. 2 illustrates an example system 200 in accordance with some implementations of the subject technology. In an example, the system 200 may be implemented in the user device 110 or the server 120. In another example, the system 200 may be implemented either in a single device or in a distributed manner in a plurality of devices, the implementation of which would be apparent to a person skilled in the art.

In an example, the system 200 may include a processor 202, memory 204 (memory device) and a communication unit 210. The memory 204 may store data 206 and one or more LLMs 208A. In an example, the system 200 may include or may be communicatively coupled with a storage 212. Thus, the storage 212 may be either an internal storage or an external storage. In the example of FIG. 2, the system 200 includes one or more camera(s) 211, a display 214, and one or more sensors(s) 216. Sensor(s) 216 may include location sensors (e.g., satellite positioning system sensors), motion sensors (e.g., inertial sensors), and/or depth sensors (e.g., stereo cameras, LIDAR sensors, radar sensors, time-of-flight sensors, or the like).

In an example, the processor 202 may be a single processing unit or multiple processing units. The processor 202 may be implemented as one or more microprocessors, microcomputers, microcontrollers, digital signal processors, central processing units (CPUs), graphics processing units (GPUs), neural processors, specialized processors, e.g., for training and/or evaluating machine learning models, such as large language models, state machines, logic circuitries, and/or any devices that manipulate signals based on operational instructions. Among other capabilities, the processor 202 is configured to fetch and execute computer-readable instructions and data stored in the memory 204.

In an example, the communication unit 210 may include one or more hardware units that support wired or wireless communication between the processor 202 and processors of other computing devices, and/or for communication over a telecommunication network.

The memory 204 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The memory 204 may include one or more applications 207 such as a text generation application and a caption generation application that are currently being executed on the system 200. The one or more applications can interact with each other or with an operating system of the system 200 using application programming interfaces (API) to send or receive data. The one or more applications and can also include respective user interfaces (UI) to facilitate user-interaction, enabling the user to provide inputs and receive output seamlessly. For example, when implemented in the user device 110, the system 200 can execute a messaging application that can provide a UI to receive inputs from the user of the user device 110.

The data 206 may represent, amongst other things, a repository of data processed, received, and generated by one or more processors such as the processor 202. One or more of the aforementioned components of the system 200 may send or receive data, for example, using one or more input/output ports and one or more communication units.

The machine learning (ML) model(s) 208 (also referred to as on-device ML models), in an example, may include one or more of machine learning models such as a LLM 208A and a LLM 208B. In an example, the machine learning model(s) 208 may be trained using training data (e.g., included in the data 206 or other data) and may be implemented by the processor 202 for performing one or more of the operations, as described herein. In an example, LLM 208A may be a general purpose LLM configured to perform a range of tasks such as text generation and completion, text translation and summarization. As for another example, the LLM 208B can be an image-to-text model configured to generate captions for multimedia elements such as images, videos, emojis, and stickers.

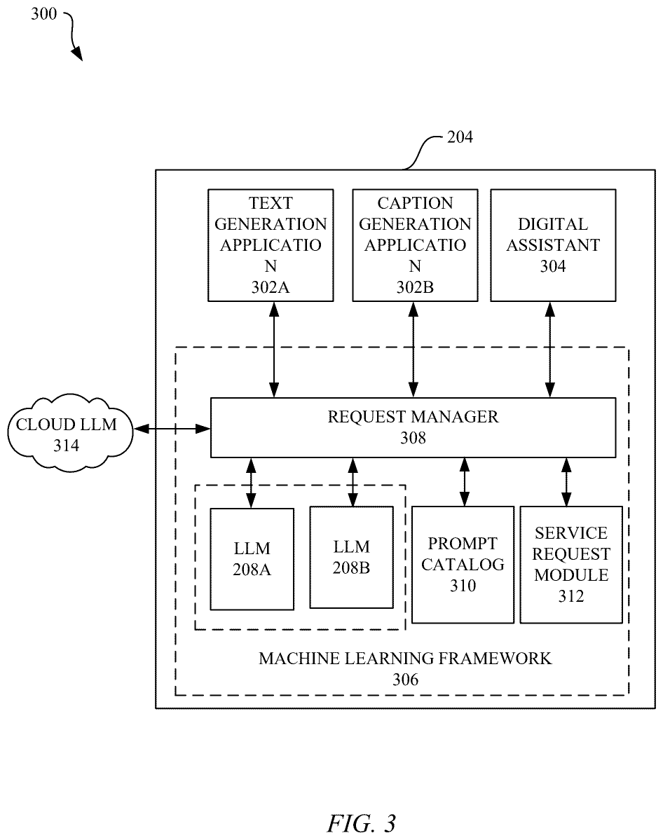

FIG. 3 illustrates an example computing environment 300 of the user device 110 in accordance with one or more implementations. The user device 110 can execute an application such as a text generation application. The text generation application can use the LLM 208A to perform a range of tasks centered around creating and manipulating text. These tasks can include generating original content such as articles or stories based on user provided input (e.g., keywords, phrases, etc.,) summarizing long texts, paraphrasing existing texts, auto-completing sentences, proof-reading text and the like. Additionally, the text generation application can correct grammar and style of text, create detailed product descriptions, personalized messages for communication and creating engaging social media content. As for another example, the user device 110 can execute a second application such as a caption generation application that is used to generate captions for images. The caption generation application can use the LLM 208B to generate captions for images, videos, emojis, and stickers for social media platforms. To execute the applications, the user device 110 can initialize the application process of the text generation application and the caption generation application, respectively. After initializing, a respective process (instance) of the text generation application and the caption generation application resides in the memory 204. As illustrated in FIG. 3, the application process of the text generation application is referred to as a text generation application 302A. Similarly, the application process of the caption generation application is referred to as a caption generation application 302B. For brevity, the terms “application” and “application process” are used synonymously in this document.

In some embodiments, the user device 110 can execute system services such as a digital assistant 304 (also referred to as virtual assistants). The digital assistant 304 can use the LLM 208A to perform a range of tasks such as interpreting complex user queries to provide relevant information or answers, setting reminders and calendar events based on spoken commands, sending messages and emails by accurately transcribing and understanding user intent and offering personalized recommendations by analyzing the context and user preferences. Additionally, digital assistant 304 can use the LLM 208A to process and understand transcribed voice commands for controlling smart home devices that are connected to the user device 110, providing contextual weather updates, etc., to provide a seamless user experience.

In some embodiments, the user device 110 includes a ML framework 306 that provides the necessary infrastructure for the execution of inference and/or generative tasks that utilize the ML model(s) 208. The ML framework 306 refers to on-device ML models that includes execution instances of the ML model(s) 208 (e.g., the LLM 208A and the LLM 208B). The user device 110 further includes a request manager 308, a catalog 310 and a service request module 312. The components of the on-device ML framework 306 reside in the memory 204 of the user device 110.

In some embodiments, a request manager 308 is a system service that is configured as an interface for the on-device ML models and the applications and/or other system services executing on the user device 110. The request manager 308 can execute as a daemon process and is responsible for handling all incoming requests for executing inference and/or generative tasks that utilize any of the on-device ML models or cloud-based ML models (e.g., cloud LLM 314). In some embodiments, the request manager 308 can be an operating system (OS) of the user device 110, an application providing an ML platform, or a middleware provided by a third-party ML service provider.

In some embodiments, the catalog 310 stores information describing the various ML models available on the user device 110 and on the server 120 as well as multiple prompt templates that can be used by the request manager 308 to create prompts for executing inference and/or generative tasks on the ML models. In some embodiments, the catalog 310 can be implemented as a part of a model catalog that can organize and store information relevant to various ML models available on the user device 110 and on the server 120 and/or adapters.

In some embodiments, the catalog 310 can be managed by the request manager 308. In some embodiments, the catalog 310 is part of a secure system that can be accessed only by the request manager 308. For example, any updates to the catalog 310 can be performed only by the request manager 308.

In some embodiments, the catalog 310 may be integrated into the operating system (OS) of the user device 110 and exposed through an API to developers, providing them with access to the ML models as well as the tasks that can be performed using the ML models. The catalog 310 may be configured for over-the-air (OTA) updates, allowing for the addition or modification of prompt templates. The catalog 310 may be accessed via the API to determine the available ML models and tasks, their functionalities, and memory constraints. As such, this information can be used to select the appropriate ML model by the requesting application.

In some embodiments, a prompt template is a predefined structure or format used to generate consistent and effective prompts for providing inputs to ML models such as the on-device ML models and cloud-based ML models. Prompt templates can include multiple variable length placeholders where inputs and instructions can be inserted to generate a prompt. These inputs and instructions can be either provided by the user of the user device 110, and/or an application process requesting the execution of the inference and/or the generative task, and/or a system services and/or one or additional services. By including the inputs and instructions in a structured format, the prompt templates serve as a guide to shape the input provided to the on-device models ensuring clarity and precision in the instructions.

In some embodiments, each prompt template can be specific to a ML model. This specificity of the prompt templates can correspond to the requirements of the ML models. For example, the LLM 208A can specify data transformation techniques (e.g., preprocessing techniques) used to convert input from natural human language into vector format. These techniques can involve encoding algorithms, length of embedding vectors, predefined dictionaries, and specific software library implementations. Similarly, the LLM 208B can specify its own requirements for data transformation which may differ from those of the LLM 208A. Since each of the on-device models (e.g., the LLM 208A and the LLM 208B) and the cloud LLMs 314 can specify their own requirements, each prompt template can be specific to a ML model.

In some embodiments, each prompt template can be specific to a task performed by the ML models. Since a ML model can be used for a range of tasks, each prompt template can be optimized to generate a prompt that effectively delivers inputs and instructions to the ML model. For example, the LLM 208A can perform a range of tasks such as generating original content based on user provided input (e.g., keywords, phrases, etc.,) summarizing long texts, paraphrasing existing texts, auto-completing sentences, and the like. Since each ML model can be used to perform a range of tasks, each prompt template can be designed for a particular task. Each prompt template in the catalog 310 can have multiple placeholders to insert inputs and instructions for generating a prompt. In some embodiments, each prompt template specifies the input and the instructions that can be inserted into the placeholders to generate a prompt tailored for a particular task. For example, the prompt template can specify the number of inputs, the format of the inputs and instructions etc., that can be inserted in the placeholders to generate a prompt.

In some embodiments, each prompt template in the catalog 310 can be uniquely identified to ensure precise prompt generation and efficient task execution. For example, each prompt template can be associated with a unique identifier that can be structured as an alphanumeric string. This unique identifier can serve as a distinct label that distinguishes each prompt template from other templates in the catalog 310. As described before, the catalog 310 stores multiple prompt templates, each prompt template is specific to a ML model, and each ML model can perform a range of inference and/or generative tasks. For example, the user device 110 can include multiple on-device ML models such as the LLM 208A and the LLM 208B. The user device 110 can also be connected to cloud-based LLMs such as the cloud LLM 314. Each of these LLMs can specify its own requirements and perform a range of tasks. For example, the LLM 208A can specify data transformation techniques and can perform a range of tasks such as generating original content based on user provided input (e.g., keywords, phrases, etc.,) summarizing long texts, paraphrasing existing texts, auto-completing sentences, and the like. Since each prompt template can specify a combination of the above-mentioned configurations, each prompt template can be uniquely identified using the unique identifier associated to the prompt template.

In one or more other implementations, the prompt template may utilize topological prompting to define specific prompt segments where attention computations between token pairs can be omitted, leading to reductions in computational load and improvements in processing efficiency. The specific token pair configurations can be explicitly marked in the prompt template to prevent attention computations for specific pairs or specific structural regions of the prompt. In one or more implementations, topological prompting may enable the selective specification of prompt segments where attention computations are not beneficial. The subject system may therefore apply masking to prevent unnecessary attention computations in these prompt segments, leading to reductions in computational load and improvements in processing efficiency. As used herein, the term “topological prompting” may refer to the ability to define specific structural regions of a prompt where attention operations can be omitted, specifying the “topology” of attention application across the prompt content.

In one or more implementations, the attention computations may include dependency calculations between token pairs such as A→B, A→C, B→C, and B→D, resulting in an O (n²) complexity for a sequence of length n. For example, component A may be configured to attend to itself, component B may be configured to attend to itself, and component B may be configured to attend to component A. In one or more other implementations, this attention configuration may result in redundant or colliding attention paths, leading to such attention computations not to be beneficial. By adjusting the attention configuration such that component A attends only to component A, component B attends only to component B, and component B does not attend to component A, a reduction in non-beneficial attention computations can be achieved. In one or more other implementations, additional attention configurations may allow component C to attend to component C and to component B, and component B may be configured to attend to component C, component C may be configured to attend to component A, and component D may be configured to attend to both components A and B. In one or more implementations, the prompt template can optionally indicate which prompt components are configured not to engage in attention operations with other prompt components. For example, these attention configurations can be marked in the prompt template to prevent attention computations for specific token pairs or regions of a prompt. By assigning such markers in the prompt, the subject system can bypass the computation of certain attention operations, reducing the overall computational complexity. For example, the reduction in attention operations may be beneficial in lowering latency and resource consumption.

In some embodiments, the LLM 208A can be an instance of a general purpose LLM configured to perform a range of tasks such as text generation and completion, and text translation and summarization. In contrast, the LLM 208B can be an instance of a domain specific model configured to generate captions based on images. The request manager 308 is also connected to cloud-based LLMs (e.g., cloud LLM 314) that is hosted on the cloud infrastructure such as the server 120. This allows applications and system services to utilize LLMs for executing inference and/or generative tasks that would require significant computational power.

In some embodiments, to provide a seamless experience for using the on-device ML model(s) and the cloud-based LLMs, the applications and/or the system service can use the same APIs for executing inference and/or generative tasks on the on-device ML models and the cloud-based LLMs. When multiple ML models associated with a particular structured prompt are available, the unified API design allows for dynamic selection of one of the ML models based on factors such as complexity of the task, resource availability, response time requirements. For simpler or more latency sensitive tasks, on-device models (e.g., the LLM 208A and the LLM 208B) which are optimized for performance and efficiency can be utilized. Conversely, for computationally intensive tasks, the request manager 308 can route the requests to the cloud based LLMs leveraging their superior processing power and extensive capabilities. This flexibility ensures that applications and system services can deliver optimal performance and user experience by intelligently balancing the use of on-device and cloud resources.

In some embodiments, the request manager 308 is further connected to a service request module 312 that may facilitate the interaction with additional services such as search engines, email servers, external-databases, or other informational and/or computational resources etc. For example, depending upon the user's request, the digital assistant 304 might need to provide a summary of an article that is available on the Internet. In such an example, the execution of the text summarization task issued by the digital assistant 304, may involve fetching the article from the Internet and providing the article as input to the LLM 208A. As for another example, the digital assistant 304 might need to provide search results from an internet search service provider in a cohesive and user friendly manner to the user. In this example, the execution of the task issued by the digital assistant 304, may involve fetching the search results from the Internet using an internet search service provider and providing the search results as input to the LLM 208A. The LLM 208A can then process the search results to generate a response describing the search results. The response can then be transmitted to the digital assistant 304 for presentation to the user.

In some embodiments, when an application (or a system service) is required to execute an inference and/or a generative task, the application can generate an API request to execute the intended task. The API request can include one or more pre-configured and/or pre-defined data elements. These one or more pre-configured and/or pre-defined data elements can correspond to one or more requirements for the task that the application is expected to provide. For example, one of the data element can correspond to an identification of the prompt template. By providing the identification of the prompt template, the application (or the system service) can specify a selection of an ML model and a task to be executed by the selected ML model. For example, when the user uses the text generation application 302A to initiate a task for generating an email, the text generation application 302A can specify a prompt template that is tailored for a particular ML model (e.g., the LLM 208A) and the task of email generation. To do this, the text generation application 302A can provide the unique identifier associated to a prompt template stored in the catalog 310. The text generation application 302A can include the unique identifier associated to a prompt template as a pre-configured and/or pre-defined data element in the API request and transmits the API request to the request manager 308. As for another example, if the text generation application 302A wanted to use the cloud LLM 314 for generating the email, the text generation application 302A would have provided the unique identifier associated to a prompt template that is specific to the cloud LLM 314 and the task of email generation.

In some embodiments, the pre-configured and/or pre-defined data elements of the API request can correspond to the details of the intended task. These one or more pre-configured and/or pre-defined data elements can correspond to one or more requirements for the task that the application is expected to provide for the identified template. For example, the user of the user device 110 can use the UI of the text generation application 302A to instruct the text generation application 302A to generate an email for cancelling a user subscription from a newsletter. The user can also provide details such as the name of the newsletter, reasons for cancellation, and an overview of the experience the user had with the newsletter subscription. In response to the user providing these details, the text generation application 302 can include the user instructions (or description) of the task as one of the pre-configured and/or pre-defined data element.

In some embodiments, the pre-configured and/or pre-defined data elements of the API request correspond to one or more additional details specified by the user or the application initiating the API request. These one or more pre-configured and/or pre-defined data elements can correspond to one or more additional requirements such as user instructions (or description) for the task that the application is expected to provide for the identified template. In such embodiments, the application (or the system service) can request the user to provide additional details regarding the intended task and include the user's response as a pre-configured and/or pre-defined data element of the API request. For example, when the user uses the text generation application 302A to initiate a task for generating an email, the text generation application 302A can request the user to provide some user preferences regarding the email. For example, the text generation application 302A can request the user to provide a title for the email, a length of the email body and the like. If the use provides these details, the text generation application 302 can include each of these details as one of the pre-configured and/or pre-defined data element.

In some embodiments, the one or more pre-configured and/or pre-defined data elements of the API request can also specify one or more sub-tasks required to complete the intended task. A sub-task can instruct the request manager 308 to use one or more services to obtain certain results that can be provided as input to the ML models. For example, the user can use the digital assistant 304 to obtain information regarding a particular topic. For example, the user can use the UI of the digital assistant 304 to obtain information regarding a newsletter subscription service. In response, the digital assistant 304 can generate an API request for a text summarization task and specify a sub-task of obtaining (e.g., searching) information regarding the newsletter subscription service as a data element. The digital assistant 304 can also specify details that may be required for executing the sub-task. For example, the digital assistant 304 can include an additional data element in the API request specifying a service provider (e.g., a search engine) for executing the sub task.

As for another example, the user can use the digital assistant 304 for recommending restaurants at nearby locations. In this example, the digital assistant 304 can generate an API request for recommending restaurants from nearby locations to the LLM 208B. The task may specify a current location of the user device 110 as one of the pre-configured and/or pre-defined data elements in the API request. In this example, the digital assistant 304 can include a sub-task of obtaining (e.g., searching) information (e.g., restaurant names, menus, distance from the current location and reviews) regarding nearby restaurants as a data elements and the current location of the user device 110. In some embodiments, the current location of the user device 110 can be included in the same data element as the sub-task of obtaining information regarding the nearby restaurants. In other embodiments, the current location of the user device 110 can be included as an additional data element that is different from the data element specifying the sub-task of obtaining information regarding the nearby restaurants.

In some embodiments, after receiving the API request from the text generation application 302A, the request manager 308 can obtain the one or more data elements from the API request. After obtaining the one or more data elements, the request manager 308 can use the indication of the prompt template specified by the application to select a prompt template tailored for the particular ML model and intended task. For example, the request manager 308 can receive the API request for generating an email from the text generation application 302A. The request manager 308 can extract the one or more data elements where each data element refers to an input or an instruction provided by the user of the user device 110. As described before, one of the data elements also includes the unique identifier specified by the text generation application 302A. The request manager 308 can use the unique identifier to select a prompt template from the catalog 310 that has the same unique identifier.

In some embodiments, the request manager 308 can use the selected prompt template to generate a prompt for the intended task for the particular ML model. As described before, prompt templates can include multiple variable length placeholders where inputs and instructions can be inserted to generate a prompt. For example, a prompt template may specify a first placeholder to include the task description, a second placeholder to include a user description, a third placeholder to include user instructions. The request manager 308 can include the one or more data elements obtained from the API request into the placeholders of the selected prompt template. For example, the prompt template may include a pre-defined and/or pre-configured prompt text (or instructions such as a code) for a particular task along with one or more placeholders for the variables that can be provided by an application. Thus, a summarizing prompt template may be, for example, “Please summarize the following text into one or two sentences: [PLACEHOLDER],” where the [PLACEHOLDER] text is replaced by the text provided by an application as a data element. In this manner, the application cannot generate its own prompts but can only utilize the structured prompts provided by the ML framework to perform specific tasks (e.g., summarization).

Continuing with example of generating an email to cancel the user's subscription, the one or more data elements obtained from the API request received from the text generation application 302A can include the name of the newsletter, reasons for cancellation, an overview of the experience the user had with the newsletter subscription, one or more email preferences according to the user such as the number of characters in the email and the tone of the language of the email. After obtaining the one or more data elements, the request manager 308 can include the data elements in corresponding placeholders of the selected template to generate a prompt.

In some embodiments, the request manager 308 can determine whether any of the data elements of the API request correspond to a sub task specified by the application initiating the API request. If the request manager 308 identifies a sub task within the API request, it can utilize the service request module 312 to interact with the additional services to execute the sub-tasks and obtain the results by executing the sub-tasks. Continuing with the example where the user uses the digital assistant 304 to obtain information regarding a newsletter subscription service, the request manager 308 can determine that one of the data elements involves a subtask of gathering information about a newsletter subscription service.

In response to determining that the API request includes a sub-task, the request manager 308 can transmit the sub-task to the service request module 312. The service request module 312, can communicate with the additional service providers to generate a result. For example, the request manager 308 can transmit the sub-task of gathering information about a newsletter subscription service to the service request module 312. In response to receiving the sub-task, the service request module 312 can initiate a search operation, collect relevant information, and generate a result by compiling all the relevant information. For example, the Internet search provider specified by the digital assistant 304 can perform an online search for the newsletter subscription service and generate a result by compiling all relevant information regarding the newsletter subscription service. In some embodiments, the service request module 312 can transmit the result back to the request manager 308. After receiving the results, the request manager 308 can include the result into the selected prompt template to generate a prompt.

As for another example, the request manager 308 can determine that one of the data elements involves a subtask of searching nearby restaurants. In response, the request manager 308 can transmit the sub-task and the current location of the user device 110 to the service request module 312. The service request module 312, can communicate with an additional service provider to generate a result. The service request module 312 can initiate a search operation using search providers to collect relevant information such as a list of restaurants near the current location, reviews associated to each of the restaurant in the list, the menu of each restaurant in the list, and generate a result by compiling all the relevant information. The service request module 312 can transmit the result back to the request manager 308. After receiving the result, the request manager 308 can include the result into the selected prompt template to generate a prompt.

In some embodiments, the request manager 308 can verify whether the one or more data elements obtained from the API request adheres to the attributes of the placeholders of the selected template, such as the data types, the data sizes, or generally any attributes of the placeholders. For example, assume the caption generation application 302B transmits an API request to generate a caption for an image using the LLM 208B. To provide the image to the LLM 208B, the caption generation application 302B can include the image as a first data element of the API request and an indication of the prompt template as a second data element. After receiving the API request, the request manager 308 can select a prompt template based on the indication of the prompt template that was included in the API request. Assume that the selected prompt template includes a placeholder for including an image. If the request manager 308 determines that first data element is an image, the request manager 308 can generate a prompt by including the images in the placeholder of the selected template. However, if the request manager 308 determines that first data element obtained from the API request is not an image, the request manager 308 can terminate (or pause) the prompt generation process. In response to determining that one or more data elements obtained from the API request does not adhere to the placeholders of the selected prompt template, the request manager 308 can transmit a notification to the application issuing the API request.

As for another example, assume that a chatbot application responsible for generating responses using the LLM 208A is executing on the user device 110. The chatbot application can transmit an API request to generate a response for a query. The API request can include the query as the first data element and an indication of the prompt template as the second data element. After receiving the API request, the request manager 308 can select a prompt template based on the indication of the prompt template that was included in the API request. Assume that the selected prompt template includes a placeholder for the query and a placeholder for a response type (e.g., informational, instructional, confirmation response) both of which are mandatory for generating a prompt. In this case, the request manager 308 can determine that the data elements obtained from the API request is not sufficient thereby not adhering to the placeholders of the selected prompt template. In response, the request manager 308 can terminate (or pause) the prompt generation process.

In some embodiments, the request manager 308 can transmit the generated prompt to the ML model that is specific to the selected prompt template. The ML model can process the prompt and generate an output. Continuing with the example of generating an email to cancel the user's subscription, the request manager 308 can transmit the prompt to the LLM 208A. The LLM 208A can process the prompt and generate an email as output. With reference to the example of recommending nearby restaurants, the request manager 308 can transmit the prompt to the LLM 208A. The described before, the request manager 308 included the result of searching the nearby restaurants into the selected prompt template to generate a prompt. The LLM 208A can process the prompt including the list of restaurants near the current location, reviews associated to each respective restaurant, the menu of each respective restaurant to select a restaurant as an output for recommendation.

In some embodiments, the ML model after processing the prompt and generating an output, transmits the output to the request manager 308. In response to receiving the output, the request manager 308 can generate an API response to include the output of the ML model. The API response is then transmitted to the application or the system services that initiated the API request. Continuing with the example of generating an email to cancel the user's subscription, the request manager 308 can generate an API response and include the generated email body in the API response. The API response is then transmitted to the text generation application 302A. In response, the text generation application 302A can display the generated email on the user device 110. As for another example, the request manager 308 can generate another API response and include the restaurant selected by the LLM 208A into the API response. The API response is then transmitted to the digital assistant 304. In response, the digital assistant 304 can display the selected restaurant on the user device 110.

In some embodiments, the request manager 308 and the catalog 310 can be implemented on the server 120 that hosts the cloud LLM 314. In such embodiments, the catalog 310 can include prompt templates specific to the cloud based ML models (e.g., cloud LLM 314.) If an application generates an API request for executing an inference and/or generative task on the cloud LLM 314, the API request can be redirected to the server 120. For example, the application requesting an inference and/or generative task, can transmit the API request to the request manager 308 implemented on the user device 110. The request manager 308 of the user device 110 can determine that the indicated ML model is hosted on the server 120. In response, the request manager 308 can re-direct the API request to the request manager 308 of the server 120. The request manager 308 of the server 120 can then follow the same techniques and methods described in this document to select a prompt template specific the cloud LLM 314 to generate a prompt and provide the prompt as an input to the cloud LLM 314 to generate an output. After generating the output using the cloud LLM 314, the request manager 308 of the server 120 can transmit the output to the application requesting the inference and/or the generative task.

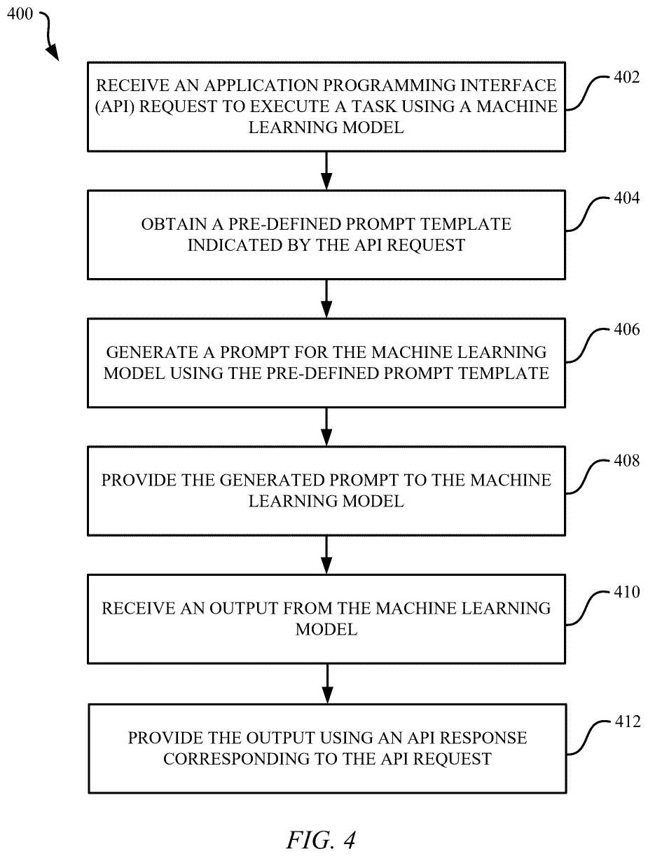

FIG. 4 is a flowchart illustrating an example process 400 of generating prompts according to aspects of the subject technology. For explanatory purposes, the process 400 is primarily described herein with reference to the user device 110 and the server 120 of FIG. 1. However, the process 400 is not limited to the user device 110 and the server 120 of FIG. 1, and one or more blocks (or operations) of the process 400 may be performed by one or more other suitable devices. Further for explanatory purposes, the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

At block 402, the request manager 308 receives an API request to execute a task using a ML model. For example, when an application (or a system service) is required to execute an inference and/or a generative task, the application can generate an API request to execute the intended task. The API request can include one or more pre-configured and/or pre-defined data elements. These one or more pre-configured and/or pre-defined data elements can correspond to one or more requirements for the task that the application is expected to provide. The one or more data elements of the API request can include an indication of the prompt template stored on the catalog 310 that the application (or the system service) intends to use. For example, if the text generation application 302A initiates a task for generating an email, the text generation application 302A can specify the prompt template that is tailored for a particular ML model (e.g., the LLM 208A) and the task of email generation. To do this, the text generation application 302A can identify the unique identifier associated to a prompt template stored in the catalog 310. The text generation application 302A can include the unique identifier associated to a prompt template in the API request as a pre-configured and/or pre-defined data element and transmits the API request to the request manager 308. The text generation application 302 can also include the user instructions (or description) of the task as one of the pre-configured and/or pre-defined data element.

At block 404, the request manager 308 can obtain a pre-defined (e.g., structured) prompt template indicated by the API request. For example, after receiving the API request from the text generation application 302A, the request manager 308 can obtain the one or more pre-configured and/or pre-defined data elements from the API request. After obtaining the one or more pre-configured and/or pre-defined data elements, the request manager 308 can use the indication of the prompt template specified by the application to select a prompt template tailored for the particular ML model and intended task. For example, the request manager 308 can receive the API request for generating an email from the text generation application 302A. The request manager 308 can extract the pre-configured and/or pre-defined data element that refers to the unique identifier specified by the text generation application 302A. The request manager 308 can use the unique identifier to select a prompt template from the catalog 310 that has the same unique identifier.

At block 406, the request manager 308 generates a prompt for the machine learning model using the pre-defined prompt template. For example, the request manager 308 can use the selected prompt template to generate a prompt for the intended task for the particular ML model. The request manager 308 can include the one or more pre-configured and/or pre-defined data elements obtained from the API request into specific placeholders of the selected prompt template. With reference to the example of generating an email to cancel the user's subscription, the one or more data elements obtained from the API request received from the text generation application 302A can include the name of the newsletter, reasons for cancellation, an overview of the experience the user had with the newsletter subscription, one or more email preferences according to the user such as the number of characters in the email and the tone of the language of the email. After obtaining the one or more data elements, the request manager 308 can include the data elements in corresponding placeholders of the selected template to generate a prompt.

At block 408, the request manager 308 provides the generated prompt to the machine learning model. For example, the request manager 308 can transmit the generated prompt to the ML model that is specific to the selected prompt template. With reference to the example of generating an email to cancel the user's subscription, the request manager 308 can transmit the prompt to the LLM 208A for processing.

At block 410, the request manager 308 receive an output from the machine learning model. For example, the ML model can process the prompt and generate an output. With reference to the example of generating an email to cancel the user's subscription, the LLM 208A can process the prompt and generate an email as output.

At block 412, the request manager 308 provides the output using an API response to the user device 110 corresponding to the API request. For example, the request manager 308 can generate an API response to include the output of the ML models. The request manager 308 can then transmit the API response to the application (or the system services) that initiated the API request. With reference to the example of generating an email to cancel the user's subscription, the request manager 308 can generate an API response and include the generated email into the API response. The API response is then transmitted to the text generation application 302A.

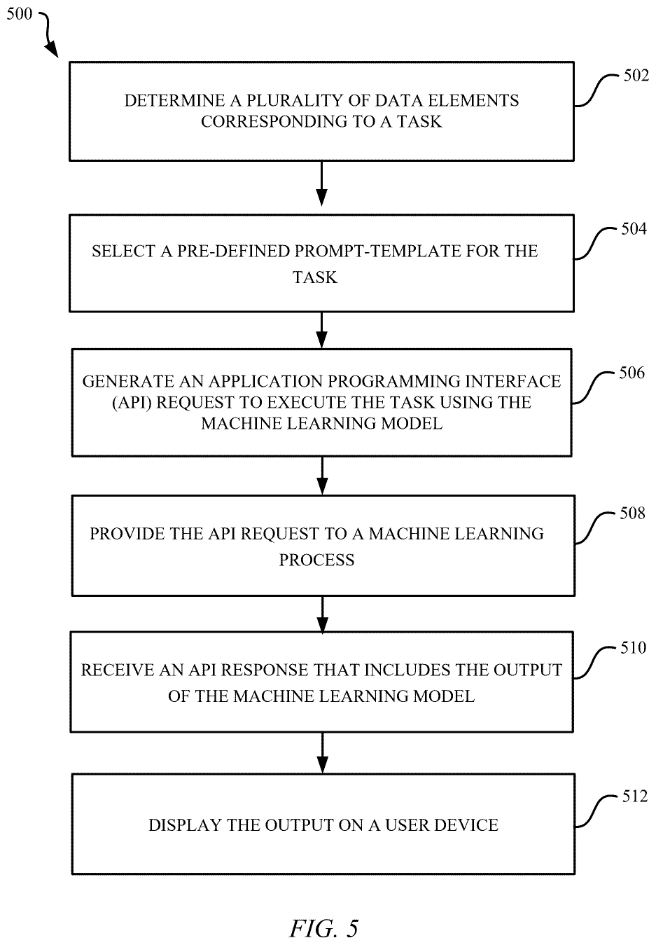

FIG. 5 is a flowchart illustrating an example process 500 of generating structured prompts according to aspects of the subject technology. For explanatory purposes, the process 500 is primarily described herein with reference to the user device 110 and the server 120 of FIG. 1. However, the process 500 is not limited to the user device 110 and the server 120 of FIG. 1, and one or more blocks (or operations) of the process 500 may be performed by one or more other suitable devices. Further for explanatory purposes, the blocks of the process 500 are described herein as occurring in serial, or linearly. However, multiple blocks of the process 500 may occur in parallel. In addition, the blocks of the process 500 need not be performed in the order shown and/or one or more blocks of the process 500 need not be performed and/or can be replaced by other operations.

At block 502, the application process determines one or more data elements corresponding to a task. When an application is required to execute an inference and/or a generative task, the application can determine one or more data elements that can be provided to the ML model. These one or more data elements can include inputs and instructions provide by the user of the user device 110. The one or more data elements can also include one or more sub-tasks for obtaining results that can be provided as input to the ML model. For example, the user of the user device 110 can use the UI of the text generation application 302A to instruct the text generation application 302A to generate an email for cancelling a user subscription from a newsletter. The user can use a text prompt provided by the application 302A to provide inputs and instructions for generating the email.

At block 504, the application process selects a pre-defined prompt template for the task. Since each prompt template can be specific to a ML model and the task performed by the ML model, the application process can select a pre-defined template that is tailored to meet the requirements specified by the ML model for the particular task. For example, the application can determine which ML model from among the available ML models (e.g., on-device models such as LLM 208A or 208B, or cloud LLM 314) can be selected to execute the inference and/or the generative task. Depending upon the ML model and the task, the application can identify a prompt template. For example, if the text generation application 302A initiates a task for generating an email, the text generation application 302A can specify the prompt template that is tailored for a particular ML model (e.g., the LLM 208A) and the task of email generation. To do this, the text generation application 302A can identify the unique identifier associated to a prompt template stored in the catalog 310.

At block 506, the application process generates an API request to execute the task using the ML model. For example, the application can generate an API request to execute the inference and/or the generative task. The API request can include one or more pre-configured and/or pre-defined data elements that correspond to the one or more requirements for the task that the application is expected to provide. The one or more data pre-configured and/or pre-defined elements can include an indication of the prompt template that the application intends to use. For example, the text generation application 302A can include the unique identifier associated to a prompt template as a pre-configured and/or pre-defined data element in the API request. The text generation application 302 can also include the user instructions (or description) of the task as one of the pre-configured and/or pre-defined data element.

At block 508, the application process provides the API request to a machine learning process. The application can generate an API request that includes one or more data elements and transmits the API request to the request manager 308. For example, the text generation application 302A can include the unique identifier associated to a prompt template along with user input and instructions as one or more data elements in the API request and transmits the API request to the request manager 308.

At block 510, the application process receives an API response corresponding to the API request. For example, the request manager 308 can use the unique identifier from the API request to select a prompt template from the catalog 310. The request manager 308 can then include one or more data elements from the API request into the selected prompt template to generate a prompt. After generating the prompt, the request manager 308 can transmit the prompt to the intended ML model. In response to receiving the prompt, the intended ML model can process the prompt to generate an output. The request manager 308 can generate an API response that includes the output generated by the intended ML model and transmits the API response to the application. For example, the request manager 308 can include the generated email by the LLM 208A into the API response and transmits the API response to the text generation application 302A.

At block 512, the application displays the output on the user device. For example, the text generation application 302A can display the generated email on the user device 110 for user review.

In some embodiments, the techniques and methods described in this document includes receiving, by a system process and from an application process, an application programming interface (API) request to execute a task using a machine learning model, the API request including a plurality of data elements corresponding to the task and the API request being indicative of a pre-defined prompt template; obtaining, by the system process, the pre-defined prompt template indicated by the API request; generating, by the system process, a prompt for the machine learning model by applying at least some of the plurality of data elements to the pre-defined prompt template; providing, by the system process, the generated prompt to the machine learning model; receiving, by the system process and responsive to providing the prompt, an output from the machine learning model; and providing, by the system process and to the application process, an API response corresponding to the API request, the API response including the output from the machine learning model.

In some embodiments, one of the plurality of data elements includes a prompt identifier that indicates the pre-defined prompt template. In some embodiments, the machine learning model is a large language machine learning model (LLM), wherein the LLM is trained to process the generated prompt to generate the output. In some embodiments, generating, by the system process, the prompt for the machine learning model by applying at least some of the plurality of data elements to the pre-defined prompt template includes verifying, by the system process, that the plurality of data elements of the API request conform with the obtained prompt template prior to generating the prompt. In some embodiments, verifying, by the system process, that the plurality of data elements of the API request conform with the obtained prompt template includes: determining one or more data formats associated with the plurality of data elements; and determining that the one or more data formats associated with the plurality of data elements conforms with one or more data formats specified by the prompt template. In some embodiments, at least one of the plurality of data elements includes a sub-task and generating the prompt includes executing the sub-task to obtain a respective result for the at least one of the plurality of data elements. In some embodiments, generating the prompt includes applying the respective result to the pre-defined prompt template.

In some embodiments, a computer program product includes code stored in a tangible computer-readable storage medium is provided. The code includes code for receiving, by a system process and from an application process, an application programming interface (API) request to execute a task using a machine learning model, the API request including a plurality of data elements corresponding to the task and the API request being indicative of a pre-defined prompt template; code for obtaining, by the system process, the pre-defined prompt template indicated by the API request; code for generating, by the system process, a prompt for the machine learning model by applying at least some of the plurality of data elements to the pre-defined prompt template; code for providing, by the system process, the generated prompt to the machine learning model; code for receiving, by the system process and responsive to providing the prompt, an output from the machine learning model; and code for providing, by the system process and to the application process, an API response corresponding to the API request, the API response including the output from the machine learning model.

In some embodiments, a system that includes a processor and a memory device containing instructions which, when executed by the processor, cause an application process to: obtain a plurality of data elements corresponding to a task for a machine learning model; select a pre-defined prompt-template for the task; generate an application programming interface (API) request to execute the task using the machine learning model, the API request includes the plurality of data elements, wherein one of the plurality of data elements includes a prompt identifier that indicates the selected prompt template; provide the API request to a machine learning process; receive, from the machine learning process, an API response corresponding to the API request, the API response including an output of the machine learning model, wherein the output corresponds to a prompt generated by the machine learning process, wherein the prompt includes 1) at least a portion of the pre-defined prompt template indicated by the prompt identifier and 2) at least some of the plurality of data elements; and display the output by the application process.

In some embodiments, the plurality of data elements of the API request does not include the selected prompt template.

As described above, one aspect of the present technology is the gathering and use of data available from specific and legitimate sources for generating prompts using API requests. The present disclosure contemplates that in some instances, this gathered data may include personal information data that uniquely identifies or can be used to identify a specific person. Such personal information data can include audio data, voice samples, voice profiles, demographic data, location-based data, online identifiers, telephone numbers, email addresses, home addresses, biometric data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for generating multimedia elements using generative models and detecting one or more attributes related to the multimedia elements.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. In the example of generating prompts using API request, the present technology can be configured to allow users to select to “opt in” or “opt out” of participation in the collection and/or sharing of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level or at a scale that is insufficient for facial recognition), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, software modules and/or components.

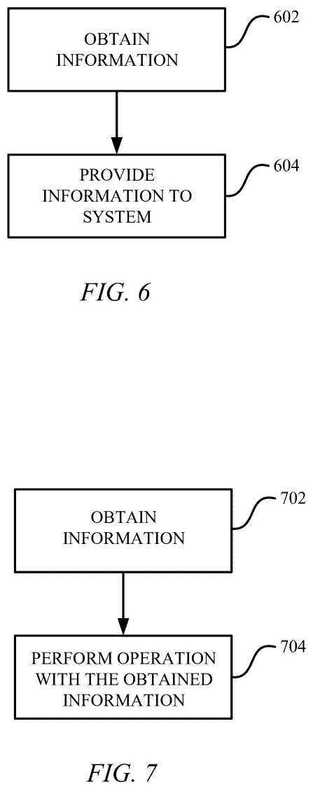

Implementations within the scope of the present disclosure include a computer-readable storage medium that encodes instructions organized as an application (e.g., application 207) that, when executed by one or more processing units, control an electronic device (e.g., user device 110) to perform the method of FIG. 6, the method of FIG. 7, and/or one or more other processes and/or methods described herein.

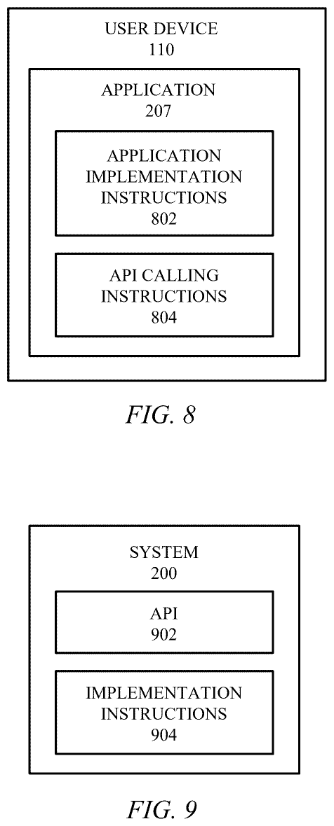

It should be recognized that application 207 (shown in FIG. 8) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 207 is an application that is pre-installed on user device 110 at purchase (e.g., a first party application). In other embodiments, application 207 is an application that is provided to user device 110 via an operating system update file (e.g., a first party application or a second party application). In other embodiments, application 207 is an application that is provided via an application store. In some embodiments, the application store can be an application store that is pre-installed on user device 110 at purchase (e.g., a first party application store). In other embodiments, the application store is a third-party application store (e.g., an application store that is provided by another application store, downloaded via a network, and/or read from a storage device).

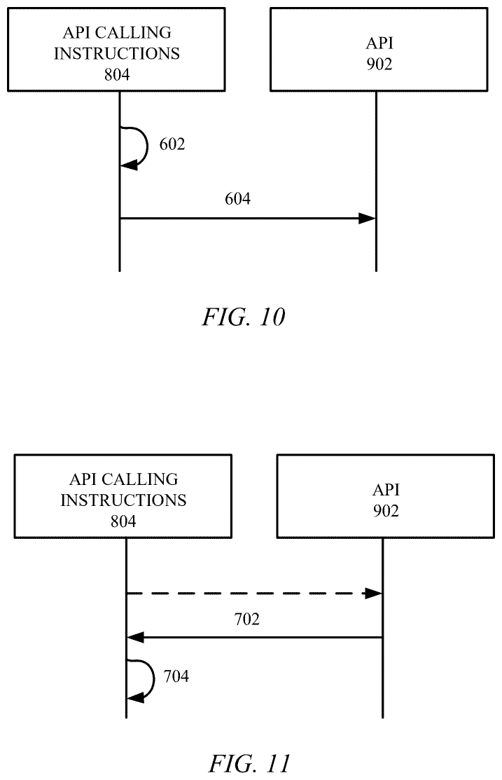

Referring to FIG. 6 and FIG. 10, application 207 obtains information (e.g., at block 602). In some embodiments, at block 602, information is obtained from at least one hardware component of the user device 110. In some embodiments, at block 602, information is obtained from at least one software module (e.g., set of instructions) of the user device 110. In some embodiments, at block 602, information is obtained from at least one hardware component external to the user device 110 (e.g., a peripheral device, an accessory device, a server, etc.). In some embodiments, the information obtained at block 602 includes positional information, time information, notification information, user information, environment information, electronic device state information, weather information, media information, historical information, event information, hardware information, and/or motion information. In some embodiments, in response to and/or after obtaining the information at block 602, application 207 provides the information to a system (e.g., at block 604).

In some embodiments, the system (e.g., block 602 shown in FIG. 6) is an operating system hosted on the user device 110. In some embodiments, the system (e.g., block 602 shown in FIG. 9) is an external device (e.g., a server, a peripheral device, an accessory, a personal computing device, etc.) that includes an operating system.

Referring to FIG. 7 and FIG. 11, application 207 obtains information (e.g., block 702). In some embodiments, the information obtained at block 702 includes positional information, time information, notification information, user information, environment information electronic device state information, weather information, media information, historical information, event information, hardware information and/or motion information. In response to and/or after obtaining the information at block 702, application 207 performs an operation with the information (e.g., block 704). In some embodiments, the operation performed at block 704 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 200 based on the information.

In some embodiments, one or more steps of the method of FIG. 6 and/or the method of FIG. 7 is performed in response to a trigger. In some embodiments, the trigger includes detection of an event, a notification received from system 200, a user input, and/or a response to a call to an API provided by system 200.

In some embodiments, the instructions of application 207, when executed, control user device 110 to perform the method of FIG. 6 and/or the method of FIG. 7 by calling an application programming interface (API) (e.g., API 902) provided by system 200. In some embodiments, application 207 performs at least a portion of the method of FIG. 6 and/or the method of FIG. 7 without calling API 902.

In some embodiments, one or more steps of the method of FIG. 6 and/or the method of FIG. 7 includes calling an API (e.g., API 902) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 8, user device 110 is illustrated. In some embodiments, user device 110 is a personal computing device, a smart phone, a smart watch, a fitness tracker, a head mounted display (HMD) device, a media device, a communal device, a speaker, a television, and/or a tablet. User device 110 includes application 207 and an operating system (not shown) (e.g., system 200 shown in FIG. 9). Application 207 includes application implementation instructions 802 and API calling instructions 804. System 200 includes API 902 and implementation instructions 904. It should be recognized that user device 110, application 207, and/or system 200 can include more, fewer, and/or different components than illustrated in FIGS. 8 and 9.

In some embodiments, application implementation instructions 802 is a software module that includes a set of one or more computer-executable instructions. In some embodiments, the set of one or more instructions of instructions 802 correspond to one or more operations performed by application 207. For example, when application 207 is a messaging application, application implementation instructions 802 can include operations to receive and send messages. In some embodiments, application implementation instructions 802 communicates with API calling instructions to communicate with system 200 via API 902 (shown in FIG. 9).

In some embodiments, API-calling instructions 804 is a software module that includes a set of one or more computer-executable instructions.

In some embodiments, implementation instructions 904 is a software module that includes a set of one or more computer-executable instructions.

In some embodiments, API 902 is a software module that includes a set of one or more computer-executable instructions. In some embodiments, API 902 provides an interface that allows a different set of instructions (e.g., API calling instructions 804) to access and/or use one or more functions, methods, procedures, data structures, classes, and/or other services provided by implementation instructions 904 of system 200. For example, API-calling instructions 804 can access a feature of implementation instructions 904 through one or more API calls or invocations (e.g., embodied by a function or a method call) exposed by API 902 and can pass data and/or control information using one or more parameters via the API calls or invocations. In some embodiments, API 902 allows application 207 to use a service provided by a Software Development Kit (SDK) library. In other embodiments, application 207 incorporates a call to a function or method provided by the SDK library and provided by API 902 or uses data types or objects defined in the SDK library and provided by API 902. In some embodiments, API-calling instructions 804 makes an API call via API 902 to access and use a feature of implementation instructions 904 that is specified by API 902. In such embodiments, implementation instructions 904 can return a value via API 902 to API-calling instructions 804 in response to the API call. The value can report to application 207 the capabilities or state of a hardware component of user device 110, including those related to aspects such as input capabilities and state, output capabilities and state, processing capability, power state, storage capacity and state, and/or communications capability. In some embodiments, API 902 is implemented in part by firmware, microcode, or other low level logic that executes in part on the hardware component.

In some embodiments, API 902 allows a developer of API-calling instructions 804 (which can be a third-party developer) to leverage a feature provided by implementation instructions 904. In such embodiments, there can be one or more set of API-calling instructions (e.g., including API-calling instructions 804) that communicate with implementation instructions 904. In some embodiments, API 902 allows multiple sets of API-calling instructions written in different programming languages to communicate with implementation instructions 904 (e.g., API 902 can include features for translating calls and returns between implementation instructions 904 and API-calling instructions 804) while API 902 is implemented in terms of a specific programming language. In some embodiments, API-calling instructions 804 calls APIs from different providers such as a set of APIs from an OS provider, another set of APIs from a plug-in provider, and/or another set of APIs from another provider (e.g., the provider of a software library) or creator of the another set of APIs.

Examples of API 902 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of user device 110. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 904 is a system (e.g., operating system, server system) software module (e.g., a collection of computer-readable instructions) that is constructed to perform an operation in response to receiving an API call via API 902. In some embodiments, implementation instructions 904 is constructed to provide an API response (via API 902) as a result of processing an API call. By way of example, implementation instructions 904 and API-calling instructions 804 can each be any one of an operating system, a library, a device driver, an API, an application program, or other module. It should be understood that implementation instructions 904 and API-calling instructions 804 can be the same or different type of software module from each other. In some embodiments, implementation instructions 904 is embodied at least in part in firmware, microcode, or other hardware logic.

In some embodiments, implementation instructions 904 returns a value through API 902 in response to an API call from API-calling instructions 804. While API 902 defines the syntax and result of an API call (e.g., how to invoke the API call and what the API call does), API 902 might not reveal how implementation instructions 904 accomplishes the function specified by the API call. Various API calls are transferred via the one or more application programming interfaces between API-calling instructions 804 and implementation instructions 904. Transferring the API calls can include issuing, initiating, invoking, calling, receiving, returning, and/or responding to the function calls or messages. In other words, transferring can describe actions by either of API-calling instructions 804 or implementation instructions 904. In some embodiments, a function call or other invocation of API 902 sends and/or receives one or more parameters through a parameter list or other structure.

In some embodiments, implementation instructions 904 provides more than one API, each providing a different view of or with different aspects of functionality implemented by implementation instructions 904. For example, one API of implementation instructions 904 can provide a first set of functions and can be exposed to third party developers, and another API of implementation instructions 904 can be hidden (e.g., not exposed) and provide a subset of the first set of functions and also provide another set of functions, such as testing or debugging functions which are not in the first set of functions. In some embodiments, implementation instructions 904 calls one or more other components via an underlying API and thus be both a set of API calling instructions and a set of implementation instructions. It should be recognized that implementation instructions 904 can include additional functions, methods, classes, data structures, and/or other features that are not specified through API 902 and are not available to API calling instructions 804. It should also be recognized that API calling instructions 804 can be on the same system as implementation instructions 904 or can be located remotely and access implementation instructions 904 using API 902 over a network. In some embodiments, implementation instructions 904, API 902, and/or API-calling instructions 804 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, process 400 (FIG. 4) and process 500 (FIG. 5) is performed at the system 200 implemented in the user device 110 or the server 120 (as described herein) via a system process (e.g., an operating system process, a system process) that is different from one or more applications executing and/or installed on the system 200.

In some embodiments, the process 400 (FIG. 4) and the process 500 (FIG. 5) is performed at the system 200 (as described herein) by an application that is different from a system process. In some embodiments, the instructions of the application, when executed, control the system 200 to perform the process 400 (FIG. 4) and the process 500 (FIG. 5) by calling an application programming interface (API) provided by the system process. In some embodiments, the application performs at least a portion of the process 400 (FIG. 4) and the process 500 (FIG. 5) without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the system 200 at purchase (e.g., a first party application). In other embodiments, the application is an application that is provided to the system 200 via an operating system update file (e.g., a first party application). In other embodiments, the application is an application that is provided via an application store. In some implementations, the application store is pre-installed on the system 200 at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the system 200 to perform the process 400 (FIG. 4) and the process 500 (FIG. 5) by calling an application programming interface (API) provided by the system process using one or more parameters.

In some embodiments, at least one API is a software module (e.g., a collection of computer-readable instructions) that provides an interface that allows a different set of instructions (e.g., API calling instructions) to access and use one or more functions, methods, procedures, data structures, classes, and/or other services provided by a set of implementation instructions of the system process. The API can define one or more parameters that are passed between the API calling instructions and the implementation instructions.

As described above, in some embodiments, the application controls the system 200 to perform the process 400 (FIG. 4) and the process 500 (FIG. 5) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API.

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call. In some embodiments, the set of implementation instructions is included in the device (e.g., user device 110) that runs the application. In some embodiments, the set of implementation instructions is included in an electronic device that is separate from the device that runs the application.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some Al processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an Al process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

FIG. 12 illustrates an electronic system 1200 with which one or more implementations of the subject technology may be implemented. The electronic system 1200 can be, and/or can be a part of, server 120 and/or user device 110 shown in FIG. 1. The electronic system 1200 may include various types of computer readable media and interfaces for various other types of computer readable media. The electronic system 1200 includes a bus 1208, one or more processing unit(s) 1212, a system memory 1204 (and/or buffer), a ROM 1210, a permanent storage device 1202, an input device interface 1214, an output device interface 1206, and one or more network interfaces 1216, or subsets and variations thereof.

The bus 1208 collectively represents all system, peripheral, and chipset buses that communicatively connect the numerous internal devices of the electronic system 1200. In one or more implementations, the bus 1208 communicatively connects the one or more processing unit(s) 1212 with the ROM 1210, the system memory 1204, and the permanent storage device 1202. From these various memory units, the one or more processing unit(s) 1212 retrieves instructions to execute and data to process in order to execute the processes of the subject disclosure. The one or more processing unit(s) 1212 can be a single processor or a multi-core processor in different implementations.

The ROM 1210 stores static data and instructions that are needed by the one or more processing unit(s) 1212 and other modules of the electronic system 1200. The permanent storage device 1202, on the other hand, may be a read-and-write memory device. The permanent storage device 1202 may be a non-volatile memory unit that stores instructions and data even when the electronic system 1200 is off. In one or more implementations, a mass-storage device (such as a magnetic or optical disk and its corresponding disk drive) may be used as the permanent storage device 1202.

In one or more implementations, a removable storage device (such as a floppy disk, flash drive, and its corresponding disk drive) may be used as the permanent storage device 1202. Like the permanent storage device 1202, the system memory 1204 may be a read-and-write memory device. However, unlike the permanent storage device 1202, the system memory 1204 may be a volatile read-and-write memory, such as random-access memory. The system memory 1204 may store any of the instructions and data that one or more processing unit(s) 1212 may need at runtime. In one or more implementations, the processes of the subject disclosure are stored in the system memory 1204, the permanent storage device 1202, and/or the ROM 1210. From these various memory units, the one or more processing unit(s) 1212 retrieves instructions to execute and data to process in order to execute the processes of one or more implementations.

The bus 1208 also connects to the input and output device interfaces 1214 and 1206. The input device interface 1214 enables a user to communicate information and select commands to the electronic system 1200. Input devices that may be used with the input device interface 1214 may include, for example, alphanumeric keyboards and pointing devices (also called “cursor control devices”). The output device interface 1206 may enable, for example, the display of images generated by electronic system 1200. Output devices that may be used with the output device interface 1206 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 12, the bus 1208 also couples the electronic system 1200 to one or more networks and/or to one or more network nodes, such as the user device 110 shown in FIG. 1, through the one or more network interface(s) 1216. In this manner, the electronic system 1200 can be a part of a network of computers (such as a LAN, a wide area network (“WAN”), or an Intranet, or a network of networks, such as the Internet. Any or all components of the electronic system 1200 can be used in conjunction with the subject disclosure.

Implementations within the scope of the present disclosure can be partially or entirely realized as computer program products comprising code in a tangible computer-readable storage medium (or multiple tangible computer-readable storage media of one or more types) encoding one or more instructions of the code. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or segmented in a different way) all without departing from the scope of the subject technology.

Aspects of the present technology may include the gathering and use of data available from specific and legitimate sources to train machine learning models and to apply to trained machine learning models deployed in systems. The present disclosure contemplates that in some instances, this gathered data may include personal information data that uniquely identifies or can be used to identify a specific person. Such personal information data can include meta-data or other data associated with images that may include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to train a machine learning model for better performance. Accordingly, use of such personal information data enables users to have greater control of the delivered content. Further, other uses for personal information data that benefit the user are also contemplated by the present disclosure.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of training data collection, the present technology can be configured to allow users to select to “opt in” or “opt out” of participation in the collection of personal information data during registration for services or anytime thereafter. In another example, users can select not to provide mood-associated data for use as training data. In yet another example, users can select to limit the length of time mood-associated data is maintained or entirely block the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, training data can be selected based on aggregated non-personal information data or a bare minimum amount of personal information, such as the content being handled only on the user's device or other non-personal information available to as training data.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can be integrated together in a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation, or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A computer-implemented method, comprising:
receiving, by a system process and from an application process, an application programming interface (API) request to execute a task using a machine learning model, the API request including a plurality of data elements corresponding to the task and the API request being indicative of a pre-defined prompt template;
obtaining, by the system process, the pre-defined prompt template indicated by the API request;
generating, by the system process, a prompt for the machine learning model by applying at least some of the plurality of data elements to the pre-defined prompt template;
providing, by the system process, the generated prompt to the machine learning model;
receiving, by the system process and responsive to providing the prompt, an output from the machine learning model; and
providing, by the system process and to the application process, an API response corresponding to the API request, the API response including the output from the machine learning model.

2. The computer-implemented method of claim 1, wherein one of the plurality of data elements comprises a prompt identifier that indicates the pre-defined prompt template.

3. The computer-implemented method of claim 2, wherein the machine learning model is a large language machine learning model (LLM), wherein the LLM is trained to process the generated prompt to generate the output.

4. The computer-implemented method of claim 1, wherein generating, by the system process, the prompt for the machine learning model by applying at least some of the plurality of data elements to the pre-defined prompt template comprises:
prior to generating the prompt, verifying, by the system process, that the plurality of data elements of the API request conform with the obtained prompt template.

5. The computer-implemented method of claim 4, wherein verifying, by the system process, that the plurality of data elements of the API request conform with the obtained prompt template comprises:
determining one or more datatypes associated with the plurality of data elements; and
determining that the one or more datatypes associated with the plurality of data elements conforms with one or more datatypes specified by the prompt template.

6. The computer-implemented method of claim 1, wherein at least one of the plurality of data elements comprises a sub-task and generating the prompt comprises executing the sub-task to obtain a respective result for the at least one of the plurality of data elements.

7. The computer-implemented method of claim 6, wherein generating the prompt comprises applying the respective result to the pre-defined prompt template.

8. A computer program product comprising code stored in a tangible computer-readable torage medium, the code comprising:
code for receiving, by a system process and from an application process, an application programming interface (API) request to execute a task using a machine learning model, the API request including a plurality of data elements corresponding to the task and the API request being indicative of a pre-defined prompt template;
code for obtaining, by the system process, the pre-defined prompt template indicated by the API request;
code for generating, by the system process, a prompt for the machine learning model by applying at least some of the plurality of data elements to the pre-defined prompt template;
code for providing, by the system process, the generated prompt to the machine learning model;
code for receiving, by the system process and responsive to providing the prompt, an output from the machine learning model; and
code for providing, by the system process and to the application process, an API response corresponding to the API request, the API response including the output from the machine learning model.

9. The computer program product of claim 8, wherein one of the plurality of data elements comprises a prompt identifier that indicates the pre-defined prompt template.

10. The computer program product of claim 9, wherein the machine learning model is a large language machine learning model (LLM), wherein the LLM is trained to process the generated prompt to generate the output.

11. The computer program product of claim 8, wherein generating, by the system process, the prompt for the machine learning model by applying at least some of the plurality of data elements to the pre-defined prompt template comprises:
prior to generating the prompt, verifying, by the system process, that the plurality of data elements of the API request conform with the obtained prompt template.

12. The computer program product of claim 11, wherein verifying, by the system process, that the plurality of data elements of the API request conform with the obtained prompt template comprises:
determining one or more data formats associated with the plurality of data elements; and
determining that the one or more data formats associated with the plurality of data elements conforms with one or more data formats specified by the prompt template.

13. The computer program product of claim 8, wherein at least one of the plurality of data elements comprises a sub-task and generating the prompt comprises executing the sub-task to obtain a respective result for the at least one of the plurality of data elements.

14. The computer program product of claim 13, wherein generating the prompt comprises applying the respective result to the pre-defined prompt template.

15. A system, comprising:
a processor; and
a memory device containing instructions which, when executed by the processor, cause an application process to:
obtain a plurality of data elements corresponding to a task for a machine learning model;
select a pre-defined prompt-template for the task;
generate an application programming interface (API) request to execute the task using the machine learning model, the API request comprising the plurality of data elements, wherein one of the plurality of data elements comprises a prompt identifier that indicates the selected prompt template;
provide the API request to a machine learning process;
receive, from the machine learning process, an API response corresponding to the API request, the API response including an output of the machine learning model, wherein the output corresponds to a prompt generated by the machine learning process, wherein the prompt includes 1) at least a portion of the selected prompt template indicated by the prompt identifier and 2) at least some of the plurality of data elements; and
display the output by the application process.

16. The system of claim 15, wherein, the plurality of data elements of the API request does not comprise the selected prompt template.

17. The system of claim 15, wherein the machine learning model is a large language machine learning model (LLM), wherein the LLM is trained to process the generated prompt to generate the output.

18. The system of claim 15, wherein generating, by the machine learning process, the prompt for the machine learning model comprises:
applying at least some of the plurality of data elements to the pre-defined prompt template indicated by the prompt identifier, wherein applying at least some of the plurality of data elements comprises:
prior to generating the prompt, verifying, by the machine learning process, that the plurality of data elements of the API request conform with the pre-defined prompt template indicated by the prompt identifier.

19. The system of claim 15, wherein at least one of the plurality of data elements comprises a sub-task and generating the prompt comprises executing the sub-task to obtain a respective result for the at least one of the plurality of data elements.

20. The system of claim 19, wherein generating the prompt comprises applying the respective result to the pre-defined prompt template indicated by the prompt identifier.
